(19) United States
(12) Patent Application Publication
(10) Pub. No.: US 2006/0130885 A1
(43) Pub. Date: Jun. 22, 2006

(54) Installation for cleaning different objects

(76) Inventor: Thierry Garcia, Rambouillet (FR)

Correspondence Address: YOUNG & THOMPSON, 745 SOUTH 23RD STREET, 2ND FLOOR, ARLINGTON, VA, 22202, US

(21) Appl. No.: 10/526,373

(22) PCT Filed: Sep. 16, 2003
(86) PCT No.: PCT/FR03/02724

§ 371 Date: Nov. 7, 2005

(30) Foreign Application Priority Data
Sep. 16, 2002 (FR) 02/11474

(51) Int. Cl. B08B 3/00

(52) U.S. Cl. 134/166 C; 134/169 C; 134/56 R

(57) ABSTRACT

An installation used to clean objects includes: a closed loop washing circuit (5A, 5B, 5C, 5D), a rinsing circuit (7A, 5B, 5C, 5D), a single pump (8) and at least one routine operating mode. The installation also has elements for automatically controlling the operation of the pump. The automatic control elements include, as a minimum, elements for detecting a pre-determined quantity of fluid in the washing fluid storage drum (3), these elements being associated with members for detecting the position (washing/filling/rinsing) of the valve (9), such that the installation can be started up by executing a preliminary program for filling the washing fluid storage drum (3), for example, when a new reserve of clean fluid (6) has been inserted.

This invention relates to an installation for cleaning various objects, such as paint guns, by means of a cleaning fluid, such as a solvent.

It relates more particularly to a cleaning installation of the type comprising:
a closed-loop washing circuit that is found, between a washing fluid storage drum and a cleaning chamber that contains the products to be cleaned, and
a rinsing circuit that is found between a rinsing fluid reserve and the cleaning chamber whose contents are dumped into the fluid storage drum.

Today, many installations of the above-mentioned type are available to users. An example of such an installation is described in particular in Patent EP-A-0,884,114. These installations are characterized today by their complexity. They comprise in general several pumps that each feed a washing or rinsing circuit. They also generally comprise several controls, in particular foot controls, as a function of the programs to be performed. In addition, this multiplication of the elements of such installations requires, prior to the installation of cans, in particular of the washing fluid storage drum and the rinsing liquid storage drum in the installation, a transfer between said cans. This transfer requires a significant manual intervention of the operator and can produce soiling accompanied by a loss of solvent during the transfer.

Furthermore, through Patent GB-A-2,301,299, a cleaning installation, in particular of a paint gun by means of a cleaning fluid such as a solvent, is known. This cleaning installation comprises a closed-loop washing circuit and a rinsing circuit found between a rinsing fluid reserve and the cleaning chamber whose contents are dumped into the fluid storage drum. Furthermore, this installation comprises a single pump that is placed on a circuit section that is common to the washing and rinsing circuit. In this installation, from closures of the cover of the cleaning chamber, the pump extracts the fluid from the drum containing the washing fluid. This leads to the necessity of having first started up the installation by transferring a portion of the contents of the reserve that contains the rinsing fluid to the washing fluid drum. This operation, which is performed manually, has a certain number of drawbacks mentioned above.

One object of this invention is therefore to propose a cleaning installation whose design makes it possible to prevent the user from any manipulation of the cans, in particular any transfer of fluids from one can to another during the beginning of the installation.

Another object of the invention is to propose a very economical cleaning installation whose design can be extremely simplified by limiting the number of pumps and control elements necessary to the operation of the installation without thereby reducing its functionalities or degrading the cleaning.

Another object of the invention is to propose a very user-friendly installation thanks to continuous information on its state and the fact that the information is accessible on the fronts of the solvent cans.

Another object of the invention is to propose a cleaning installation that ensures a high degree of freedom of operation under the control of a network of sensors at suitable locations.

Another object of the invention is to propose a cleaning installation whose design, although extremely simplified, is completely reliable and prevents, for example, any possibility of overflow.

Another object of the invention is to propose a cleaning installation whose design makes possible its operation, as simple as possible, in an explosive atmosphere.

For this purpose, the invention has as its object an installation for cleaning various objects, such as paint guns, by means of a cleaning fluid such as a solvent, of the type that comprises:
a closed-loop washing circuit that is found between a washing fluid storage drum and a cleaning chamber that contains the products to be cleaned and
a rinsing circuit that is found between a rinsing fluid reserve and the washing chamber whose contents are dumped into the cleaning fluid storage drum,
a single pump that is placed on a section of circuit common to the washing and rinsing circuits and extending between an at least three-way valve that has at least two positions (washing/filling-rinsing) and the cleaning chamber,
at least one so-called routine mode of operation that comprises at least two programs, called respectively washing and rinsing, selected based on the position occupied by the valve, whereby each program corresponds to a circulation of the cleaning fluid in the corresponding circuit by means of the pump, characterized in that the installation also comprises means for controlling the operation of the pump that consist of at least means for detecting a predetermined amount of fluid in the washing fluid storage drum combined with means for detecting the position (washing/filling-rinsing) of the valve to make possible, in particular after installation of a new reserve of clean fluid, a start-up of the installation by executing a preliminary program for filling the washing fluid storage drum during which the pump, in the rinsing position of the valve, transfers a predetermined amount of fluid from the rinsing reserve to the washing fluid storage drum until said amount is obtained in the drum, whereby the detection of said amount allows a subsequent, so-called routine, operation of the installation.

Thanks to the design of the installation, all of the functionalities of the machine, namely a washing program and a rinsing program, are ensured while allowing an automatic transfer of fluids during the start-up of the installation without the operator having to intervene manually, whereby all of these three operations of filling, washing or rinsing can be performed by means of a single pump and optionally a single control element.

According to a preferred embodiment of the invention, the means for controlling the operation of the pump ensure that, unless there is a predetermined amount of fluid in the washing fluid storage drum, the pump will not operate with the valve in the washing position and said means allow said pump to operate with the valve in the rinsing-filling position.

Thanks to the design of this installation, the pump will not run a washing cycle under zero load.

The invention will be better understood from reading the following description of the embodiments, in reference to the accompanying drawings in which:

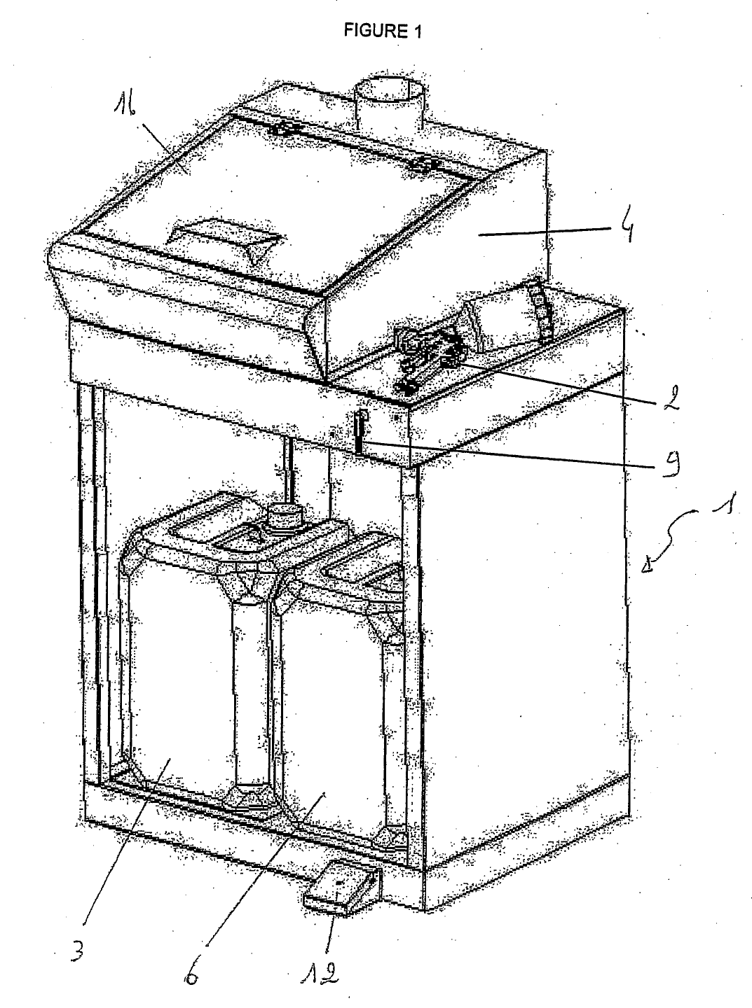

FIG. 1 shows a partial diagrammatic view of an installation according to the invention;

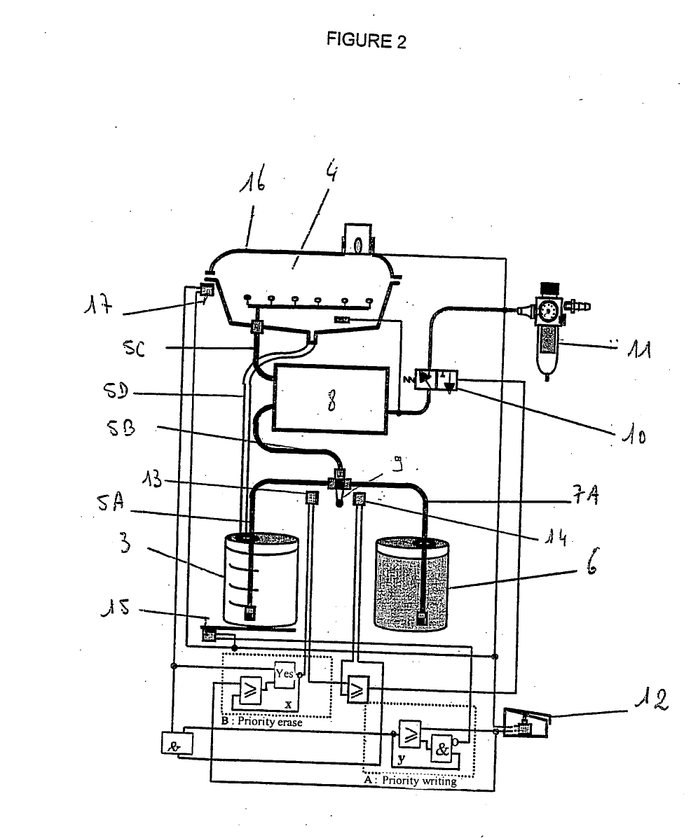

FIG. 2 shows a diagrammatic view of an installation with the associated operating logic diagram in the case of an automatic version of the machine, and

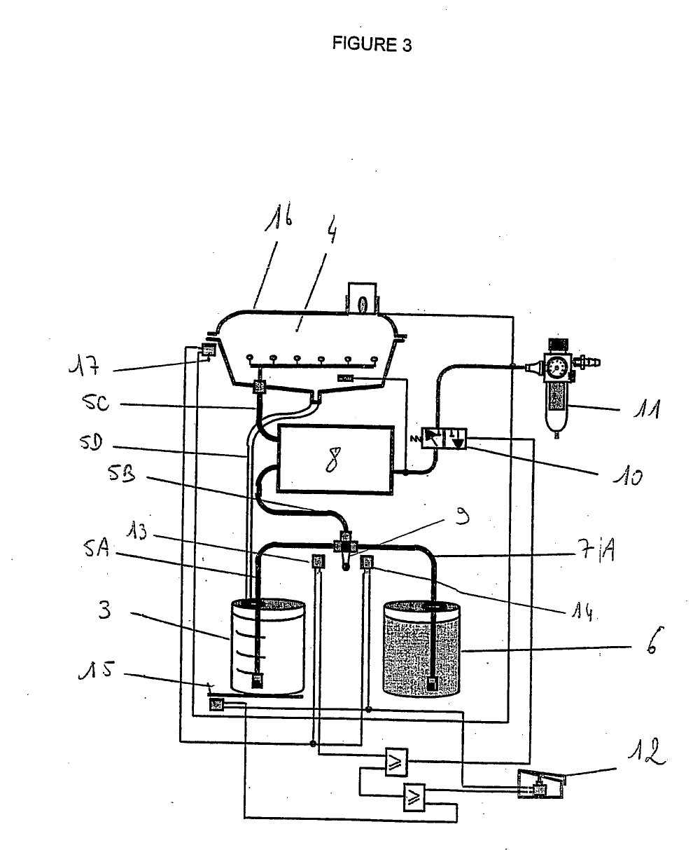

FIG. 3 shows a diagrammatic view of the installation with the associated operating logic diagram in a simplified version with manual operation of the machine.

As mentioned above, cleaning installation 1, object of the invention, makes possible the cleaning of various objects and in particular paint guns 2 by means of a cleaning fluid such as a solvent.

This installation comes in the form of a frame that delimits a cleaning chamber 4 that is generally positioned above a housing that is used in accommodating a washing fluid storage drum 3 and a drum 6 called a reserve 6 of rinsing fluid.

The installation also comprises a pump 8 and a certain number of connections between drums 3, 6 and cleaning chamber 4. Thus, the installation comprises a closed-loop washing circuit that is found between washing fluid storage drum 3 and cleaning chamber 4 that contains the products to be cleaned. Closed-loop circuit is defined as a circuit in which the washing fluid circulates from drum 3 to chamber 4 and then from chamber 4 to drum 3. This washing circuit is shown by 5A, 5B, SC, and 5D in FIGS. 2 and 3. The installation also comprises a rinsing circuit that is found between rinsing fluid reserve 6 and cleaning chamber 4 whose contents are dumped into washing fluid storage drum 3. This circuit is shown by 7A, 5B, 5C, and 5D in FIGS. 2 and 3. In a manner that is characteristic of the invention, the washing and rinsing circuits comprise a common circuit section that is shown by 5B and 5C in the figures. In this common circuit portion, placed upstream from cleaning chamber 4 viewed in the direction of movement of the fluid, a single pump 8 is positioned that will make possible the execution of all of the programs of the installation, namely the programs of filling, washing and rinsing that will be described below. This circuit portion 5B, 5C that is common to the washing and rinsing circuits extends between a valve 9 that is at least three-way and that has at least two positions (washing/filling-rinsing) and cleaning chamber 4. Valve 9 is a manual control valve. Single pump 8 is a pneumatic membrane pump coupled to a distributor 10, which in turn is connected to a regulator filter shown by 11 in FIGS. 2 and 3.

The installation also comprises two modes of operation. The first mode, also called start-up of the installation, comprises at least a filling program of washing liquid drum 3 during which pump 8, with valve 9 in the rinsing position, transfers the cleaning liquid from rinsing reserve 6 to washing fluid storage drum 3 until a predetermined amount of fluid is obtained in drum 3. The detection of this predetermined amount automatically switches the installation to the second mode of operation, the so-called routine mode of operation, which comprises at least two programs that are respectively called washing and rinsing programs that are selected based on the position occupied by valve 9. Each program corresponds to a circulation of the cleaning fluid in the corresponding circuit via pump 8.

During the start-up phase of the installation, automatically activated, in particular during the installation of a new empty drum 3 for washing fluid storage and a new full drum corresponding to rinsing fluid reserve 6, when the amount of fluid inside washing fluid storage drum 3 is less than a predetermined value, the filling of drum 3 with clean washing liquid obtained from rinsing fluid reserve 6 is performed in a first step. Actually, at the beginning, rinsing fluid reserve 6 generally consists of a full drum of new solvent fluid. This drum is installed in the location provided for rinsing fluid reserve 6. An empty drum that was generally used in a preceding cycle as a rinsing fluid reserve is positioned in the location of washing liquid storage drum 3. The user then manually carries out a rotation of the solvent drums that successively occupy the rinsing position before that of washing. The first operation that the machine executes therefore consists in transferring a portion of the fluid that is contained in rinsing fluid reserve 6 to washing fluid storage drum 3 in order to subsequently make possible the operations of washing and rinsing the guns. The fluid is transferred by making use of the rinsing circuit, namely portions 7A, 5B, 5C and 5D of the circuit. This transfer can therefore be made by means of pump 8 when valve 9, which can occupy three positions, namely a washing position, a rinsing or filling position and a shutdown or closing position, is in filling or rinsing position. This fluid transfer is done until a predetermined amount is obtained in drum 3, this amount preferably corresponding at least to the amount that is necessary to carry out a first washing of the guns. The detection of the amount automatically switches the installation into the so-called routine mode of operation that will be described below. This start-up phase is made possible thanks to the presence, in the installation, of means for controlling the operation, in particular the control, of pump 8 in the presence of a predetermined amount of fluid in washing fluid storage drum 3. These means for controlling the operation, in particular the control, of pump 8, consist of at least means for detecting a predetermined amount of fluid in washing fluid storage drum 3 combined with means for detecting the washing, filling or rinsing position of valve 9. The means for detecting the position of valve 9 can consist of two sensors 13, 14 positioned in the vicinity of valve 9. The means for detecting a predetermined amount of fluid in washing fluid storage drum 3 may affect a large number of forms. Actually, to make it possible to detect the amount of transferred fluid, a weight sensor 15 positioned close to the location of cleaning fluid storage drum 3 and optionally a sensor to detect the presence of said drum 3 may be provided. A sensor for detecting the level of washing fluid inside drum 3 may also be provided. This solution is, however, more complex to implement. These control means are active in the various so-called filling or routine modes of operation and can be combined with other means in order to start up the filling of drum 3 before any cleaning cycle.

Thanks to this operation of transfer between the two drums, several advantages result therefrom. On the one hand, during the programs of filling and rinsing the guns, no overflow whatsoever of one of the drums can be noted at any time. Furthermore, the transfer operation being performed automatically, the only manipulations to be performed by the operator will be the positioning of the drums in their reserved locations inside the installation, the transfer then being carried out automatically without the operator needing to intervene manually. When reserve 6 is empty, the operator will remove drum 3 that is filled with dirty solvent, will replace it by the empty drum that constitutes reserve 6 and will install a new drum that is filled with clean solvent as reserve 6.

This rotation further corresponds to a traditional practice of using solvents that is observed and widely used in the management of cleaning starting from at least two solvent cans. The advantage of an operation that provides systematic filling before carrying out a washing and/or rinsing cycle limits overconsumption of solvent to reduce its pollution level and invites the user to voluntarily change the solvent cans when the rinsing solvent reserve is empty. Thus, the total rinsing number will be defined as much by the remaining volume in the rinsing solvent can as by the desire of the user who himself decides the duration of the rinsing.

The purpose of allowing the user this high degree of freedom in managing cleaning, however, is to prompt him to respect the environment by better monitoring the consumption of solvents, whose recovery and treatment by appropriate means are important aspects. For this to happen, only a desire to get involved that is generated from within, not imposed from without, can ensure the positive development of good practices expected from the application of ISO 14000 standards, as well as the necessary accepting of responsibility in the individual behaviors that are generated thereby. The advantage of this invention is also to improve the value of a cleaning machine as an actual working tool that is considerate of its environment and of the user.

Based on the logic adopted for the operation of the installation, various embodiments of the invention may be considered. Thus, two embodiments of such an installation will be described below.

The first example relates to an installation whose operating logic is worked out. Thus, in this case, the installation is equipped with several sensors that are independently hardwired in an automatic state maintenance logic thanks to memory functions consisting of pneumatic cells that take into account all cases of variation of independent sensors from one another and ensuring automatic maintenance of state. Thus, in this first case of operation, corresponding to the one shown in FIG. 2, the installation comprises a number of sensors, namely sensors 13, 14 for detecting the position of valve 9 that are placed close to valve 9 and that detect the washing position, on the one hand, and the filling/rinsing position, on the other hand, of the valve, a weight sensor 15 positioned close to the location of washing fluid storage drum 3, a sensor 17 that detects the opening of an element 16 for closing cleaning chamber 4 and a detection of the actuation of a foot control 12 that will be described below. In this detailed version, when start-up occurs while the program of filling the washing liquid drum 3 that is described above is executed, pump 8 does not run with valve 9 in the washing position. Thus, during this start-up, until washing liquid storage drum 3 is filled with an amount of fluid that corresponds to a predetermined amount, the pump is able to operate with valve 9 only in the filling/rinsing position. Once this transfer is performed, the installation automatically switches into a second so-called routine mode of operation. In this routine mode of operation, two programs, respectively called washing and rinsing programs, can be carried out. These two programs are selected based on the position occupied by valve 9. Each program corresponds to a circulation of the cleaning fluid in the corresponding circuit by means of pump 8. In this routine mode of operation, pump 8 is controlled by the same actuating element 12 for the execution of the washing or rinsing program. Thus, in the examples shown, pump 8 is controlled by a single foot control 12 that ensures the starting and the execution of the washing or rinsing program based on the position that is occupied by valve 9, whereby this selection of the position is carried out by the operator who manually actuates the valve. In this routine mode of operation, pump 8 is controlled by alternating taps of foot control 12 to execute the washing program and is continuously controlled by holding down foot control 12 to execute the rinsing program. In other words, when the operator actuates foot control 12 and valve 9 is positioned in the washing position detected by sensor 13, a single tap on foot control 12 allows the automatic execution of the washing program. During this washing program, the washing fluid, removed by means of pump 8 in drum 3, passes through, in a closed loop, the circuit that is delimited by portions 5A, 5B, 5C and 5D of the circuit. This closed-loop circulation of the fluid allows a washing of the guns for a period according to the desires of the user. The washing program can be stopped either by positioning valve 9 in its shutdown or closing position or by opening closing element 16 that automatically ensures, because this opening is detected by sensor 17, a shutdown of the installation or else by a pneumatic timing system on the air supply circuit of distributor 10.

Once the washing operation has been carried out, the rinsing operation can then begin. To do this, the operator positions valve 9 in the rinsing position and again actuates foot control 12. The fluid is then transferred from rinsing fluid reserve 6 via circuit 7A, 5B, 5C to cleaning chamber 4 and then evacuated via circuit 5D into storage drum 3. During the execution of this program, pump 8 is under continuous control. In other words, the operator should keep his foot on foot control 12 continuously to allow the operation of pump 8. This makes it possible for the operator to dose in a precise and perfect manner the amount of rinsing liquid necessary to the rinsing operation. As soon as foot control 12 is released, pump 8 stops, and the rinsing operation is ended. In this case, three-way valve 9 that has three positions—closing, washing, and filling/rinsing—has the circuit selector role only in indirect mode, i.e., it does not directly control the air supply of pump 8.

It should be noted that during the start-up of the installation, the start-up of pump 8 is also optionally controlled in advance with a foot control 12. During this start-up, it actually is enough, when manual valve 9 occupies the stable filling/rinsing position detected by sensor 14, to actuate foot control 12 to initiate automatic operation of pump 8, whereby sensor 15 ensures the shutdown of this pump 8. Thus, from the start-up in the routine mode of operation, pump 8, actuated by foot control 12, passes automatically from an alternating tap control for filling to a continuous holding control for rinsing in the same rinsing/filling position of manual valve 9. These results are obtained by means of the logic adopted. This logic comprises a priority writing function with sensor 15 that allows continuous filling until it is actuated. Once sensor 15 is actuated, foot control 12 takes over only when steadily depressed by the user who manages its rinsing cycle. Sensor 17 for detecting element 16 for closing cleaning chamber 4 is taken into account for preventing the operation if cover 16 is open. This logic also comprises a priority erase function with sensor 17 that then monitors the washing cycle continuously until it is actuated by the closing of cover 16. Once sensor 17 is actuated again, only a single tap on control 12 restarts pump 8 for a washing cycle. In these two cases, manual control valve 9 that is placed in the washing or rinsing position can cancel the effect of the state memory and only a new tap on foot control 12 will restart a cleaning cycle. In this solution, the user can manage his equipment by requesting limited manual actions to ensure greater user-friendliness without increasing the cost. All the sensors are normally closed (no air in the non-actuated state). Thus, such an installation makes it possible to execute the washing operation for any period of time without running the risk of overflow of the installation. Conversely, the rinsing operation is perfectly controlled by the operator who shall decide the amount of rinsing fluid to be introduced into the cleaning chamber based on the rate at which the products become soiled.

In another embodiment of the installation shown in FIG. 3, the adopted logic is a logic that is simplified relative to that adopted in FIG. 2. Thus, states are maintained not automatically but manually thanks to a very specific organization of sensors combined with pneumatic cells that have no state memory. Thus, the solution that is shown in FIG. 3 is distinguished from that shown in FIG. 2 by the fact that in FIG. 2, pneumatic cells with state memory are used whereas in the case of FIG. 3, pneumatic cells without state memory are used. A certain number of modifications at the level of the operation of the installation result therefrom. Thus, during the start-up phase, pump 8 can be actuated, including with valve 9 in washing position. However, and in a way similar to what was described above, the rinsing program can be activated by holding down foot control 12 only starting from the time when the filling program will have been carried out in its entirety. In this second embodiment of the invention, the filling program is started by simple positioning of valve 9 in the filling/rinsing position, a position detected by sensor 14. It is not necessary to actuate foot control 12 in addition. Once the filling operation is carried out, the washing and rinsing operations in the second mode of operation are carried out in a way similar to what was described above. The differences are essentially present during the start-up phase when pump 8 is active, including with valve 9 in washing position and when it is not necessary to actuate foot control 12 to start any of the filling or washing programs. Conversely, in the routine mode of operation, again, pump 8 is controlled with the actuation of foot control element 12 for the rinsing program. In this case, three-way valve 9, with three positions—closing, washing, and filling/rinsing—has the role of a direct-mode circuit breaker, i.e., it directly controls the air supply of pump 8.

To make it possible to implement such an operation, the general supply of compressed air comes directly to sensor 17 that constitutes the sensor for detecting the opening of element 16 for closing cleaning chamber 14. Any risk of spraying solvent on the user is thus reliably prevented. Then, the established order is as follows: the air is distributed concurrently to sensors 13 and 14 corresponding to the sensors for detecting the position of valve 9. Then, sensor 13 for detecting the position of valve 9 in washing position that is used only in the start-up of the washing function with valve 9 that is actuated manually, the air is sent directly to distributor 10 that controls pump 8. Sensor 14 that is used in the detection of valve 9 in rinsing/filling position controls two operations: filling and rinsing with the valve that is actuated manually. The air is then sent to sensor 15 for detecting the filling of washing fluid storage drum 3 and to foot control 12. In this situation, sensor 15 for detecting the filling level of washing liquid drum 3 monitors the continuous filling until it is actuated, i.e., until the predetermined amount of liquid is reached. Once sensor 15 is actuated, foot control -1 2 takes over.

Thus, in short, in the case of the installation that is shown in FIG. 2, drums 3 and 6 are installed in the installation. Valve 9 is positioned in rinsing/filling position, and element 16 for closing storage chamber 4 is closed. Foot control 12 is actuated by a single tap on the pedal to ensure the start-up of pump 8. As soon as valve 9 is brought into another position or as soon as element 16 for closing cleaning chamber 4 is open, pump 8 shuts down. The operation of the pump continues until washing fluid storage drum 3 is filled with a predetermined amount of fluid. The positioning of valve 9 before the final filling of drum 3 in the washing position does not bring about any operation of pump 8. Once the filling operation has ended, the installation automatically switches into the routine mode of operation where the washing and rinsing operations are going to be able to begin. In this case, when valve 9 is positioned in its washing position, a single tap on foot control 12 makes possible the implementation of the washing program. The shutdown of this program is obtained either by opening cover 16 of cleaning chamber 4 or by positioning valve 9 in its shutdown position or by a pneumatic timing system on the air supply circuit of distributor 10. The rinsing operation is carried out by simple positioning of valve 9 in its rinsing/filling position and actuation of foot control 12 that is held down continuously until the amount of pumped rinsing is equal to that desired by the user. The washing and rinsing programs are repeated until the rinsing liquid is used up. The operator can then perform a change of drums by installing a new rinsing liquid drum 5. The installation then carries out the program of filling washing fluid storage drum 3 before beginning a new series of cycles of washing and rinsing programs. Thus, such an installation makes possible the execution of three filling, washing and rinsing programs by means of a single pump and a single foot control without running the risk of an overflow of the installation during its operation.

Because of the operation of the installation, namely a first filling phase of drum 3 to obtain a first minimum dose of washing, then a succession of washing and rinsing programs where with each washing, the dose of washing fluid is supplemented with rinsing fluid used during the immediately preceding rinsing operation, it is also noted that it is then possible to wash with an amount of fluid that increases as the fluid becomes dirty since the user himself manages the time for which foot control 12 is held down as he sees fit. The washing efficiency is thus preserved. The rinsing is always performed with clean fluid.

It should be noted that the amount of fluid transferred during the filling program is greater than that that pump 8 draws into rinsing fluid reserve 6 during the execution of a rinsing program.

1. Installation (1) for cleaning various objects, such as paint guns (2), by means of a cleaning fluid such as a solvent, of the type that comprises:
a closed-loop washing circuit (5A, 5B, 5C, 5D) that is found between a washing fluid storage drum (3) and a cleaning chamber (4) that contains the products to be cleaned, and
a rinsing circuit (7A, 5B, 5C, 5D) that is found between a rinsing fluid reserve (6) and washing chamber (4) whose contents are dumped into cleaning fluid storage drum (3),
a single pump (8) that is placed on a section (5B, 5C) of circuit common to the washing and rinsing circuits and extending between an at least three-way valve (9) that has at least two positions (washing/filling-rinsing) and cleaning chamber (4),
at least one so-called routine mode of operation that comprises at least two programs, called respectively washing and rinsing, selected based on the position occupied by the valve, whereby each program corresponds to a circulation of the cleaning fluid in the corresponding circuit by means of pump (8),
characterized in that the installation also comprises means for controlling the operation of pump (8) that consist of at least means for detecting a predetermined amount of fluid in washing fluid storage drum (3) combined with means for detecting the position (washing/filling-rinsing) of valve (9) to make possible, in particular after installation of a new reserve (6) of clean fluid, a start-up of the installation by executing a preliminary program for filling washing fluid storage drum (3) during which pump (8), with valve (9) in the rinsing position, transfers a predetermined amount of fluid from rinsing reserve (6) to washing fluid storage drum (3) until said amount is obtained in drum (3), whereby the detection of said amount allows a subsequent, so-called routine, operation of the installation.

2. Installation according to claim 1, wherein the means for controlling the operation of pump (8) ensure that, unless there is a predetermined amount of fluid in washing fluid storage drum (3), the pump will not operate with valve (9) in the washing position, and said means allow said pump (8) to operate with valve (9) in the rinsing-filling position.

3. Installation according to claim 1, wherein the means for detecting a predetermined amount of fluid in washing fluid storage drum (3) consist of a weight sensor (15) that is positioned close to the location of washing fluid storage drum (3) and optionally a sensor to detect the presence of said drum (3).

4. Installation according to claim 1, wherein the means for detecting a predetermined amount of fluid in washing fluid storage drum (3) consist of at least a sensor for detecting the fluid level inside drum (3).

5. Installation according to claim 1, wherein the means for detecting the position of valve (9) consist of two sensors (13, 14) that are positioned close to valve (9).

6. Installation according to claim 1, wherein during the start-up phase, the startup of pump (8) is also controlled with a foot control (12).

7. Installation according to claim 1, wherein in the so-called routine mode of operation, pump (8) is controlled by the same actuating element for the execution of the washing or rinsing program.

8. Installation according to claim 7, wherein in the so-called routine mode of operation, pump (8) is controlled by a single foot control (12) that ensures the starting and execution of the washing or rinsing program based on the position that is occupied by valve (9).

9. Installation according to claim 1, wherein in the so-called routine mode of operation, pump (8) is controlled by alternating single taps to execute the washing program and is continuously controlled by holding to execute the rinsing program based on the position that is occupied by valve (9).

10. Installation according to claim 1, wherein it comprises means for shutting down programs constituted by valve (9) that is positioned in a closing position or by opening an element (16) for closing cleaning chamber (4).

11. Installation according to claim 1, wherein pump (8) is a pneumatic membrane pump.
